(19) United States
(12) Patent Application Publication
(10) Pub. No.: US 2011/0035902 A1
(43) Pub. Date: Feb. 17, 2011

(54) Knob

(75) Inventor: Taiichirou Ikeda, Tokyo (JP)

Correspondence Address: RADER FISHMAN & GRAUER PLLC, LION BUILDING, 1233 20TH STREET N.W., SUITE 501, WASHINGTON, DC, 20036, US

(73) Assignee: Niles Co., Ltd., Tokyo (JP)

(21) Appl. No.: 12/805,464

(22) Filed: Aug. 2, 2010

(30) Foreign Application Priority Data
Aug. 11, 2009 (JP) 2009-186788

(51) Int. Cl. B25G 1/00

(52) U.S. Cl. 16/110.1

(57) ABSTRACT

A knob comprises a knob cap and a moving block. The knob and the moving block are connected by inserting the moving block into the knob cap and by engaging nails formed on an inner surface of an enlarged diameter portion as an opening end of the knob cap to engagement holes formed in a fitting portion of the moving block. A bottom wall of the knob cap has an inner surface provided with projections at three equally divided positions on the circumference around the axis center, the projection having a front end provided with an inclined surface. The moving block is automatically aligned with the knob cap by making a corner of the inner peripheral edge in a ring-shaped front wall be in contact with the inclined surface. There can be obtained the knob in which the moving block can be freely cut in thickness, and the knob cap and the moving block can be aligned with each other without use of an adhesive agent accompanied by any dirt or operation jobs and unified without an axial gap.

### CROSS-REFERENCE TO RELATED APPLICATION

This application is based on Japanese Patent Application No. 2009-186788 filed on Aug. 11, 2009, the disclosure of which is incorporated herein by reference.

### BACKGROUND OF THE INVENTION

1. Field of the Invention

The present invention relates to a knob used as an operational portion in a switch apparatus, for example.

2. The Related Art Of The Invention

For example, a vehicle is provided with switch apparatuses for selection of a drive mode and driving or switching other various kinds of devices. A knob for operating the switch apparatus is, for identifying the switch apparatus based upon an outside appearance thereof, provided with a component in a different color or has, for dividing a front side subject to surface finishing and a back side as a functional component, a so-called double molding in which a knob cap as the front side is formed of a resin material different from a moving block as a molding member of the back side and is further molded to be integral with the back side. For example, FIG. 15 shows a knob 110 in which an outer peripheral surface at the rear portion of a moving block 112 is connected to the rear side of a knob cap 111. When a surface of the knob cap 111 in the knob 110 is electroplated, in a case where the knob cap 111 is formed of ABS and the moving block 112 is formed of polycarbonate, the moving block is difficult to be electroplated and the knob cap 111 alone is electroplated due to different conducting properties thereof. Therefore, a boundary in the outer peripheral surface between the knob cap 111 and the moving block 112 is clear, which does not spoil the beauty of the knob 110.

In the knob 110 in FIG. 15, a moving block rear end 114 serves as a pressing portion for pressing a switch side member and at 116 and 117 are denoted functional spaces for receiving opponent members at the switch side.

Incidentally in a case of forming spaces inside the knob 110 by wall thinning for weight reduction, cost reduction of materials and the like in the knob 110, even when the wall thinning is performed in the moving block 112 from the front side thereof, a material in a melting state at the time of molding the knob cap 111 flows into the formed space and as a result, the space is filled with the material. Therefore, the space is required to be formed inside the moving block 112 from the rear side only.

However, according to the space formation by wall thinning from the rear side, narrow spaces only, such as spaces 119 and 120 shown in FIG. 15, can be formed and a sufficient draft angle to a wall thinning die can not be formed, raising a problem on degradation of formability in the knob.

In addition in a case of applying painting instead of the plating as the surface finishing of the knob cap 111, since a difference in the material therebetween does not cause a large difference in adhesive property of a paint, the paint is attached to the moving block 112, which makes difficulty in obtaining a clear boundary line between the outer peripheral surfaces of the painted knob cap 111 and the non-painted moving block 112. For overcoming this problem, an operation for applying masking to the moving block 112 in which the painting is not desired is needed, raising a problem of bringing in an increase in costs and operation hours.

In view of the above, there exists a need for a knob which overcomes the above-mentioned problem in the related art. The present invention addresses this need in the related art as well as other needs, which will become apparent to those skilled in the art from this disclosure.

### SUMMARY OF THE INVENTION

The present invention has been made from the foregoing problem and an object of the present invention is to provide a knob having a structure which can realize effective space formation by wall thinning at low costs and simply.

A knob according to a first aspect of the present invention comprises a knob cap including a bottom wall and a side wall, and a moving block including a recessed portion and fitted inside the knob cap, wherein the side wall of the knob cap is provided with nails formed at an opening end side to be oriented in a diameter inner direction, an inner surface of the bottom wall in the knob cap is provided with projections formed at three locations surrounding an axis center of the knob on the circumference corresponding to a corner of an end edge of the moving block opposing the bottom wall, the projection having an inclined surface changing in height in a radial direction from the inner surface of the bottom wall, and the moving block has an outer peripheral surface along an inner surface of the side wall of the knob cap at the opening end side, the outer peripheral surface having engagement holes corresponding to the nails, wherein the nail is engaged to the engagement hole to axially unify the knob cap and the moving block, and the corner of the end edge in the moving block is in contact with the inclined surface of the projection.

According to the first aspect of the present invention, the moving block is automatically aligned on the axis center of the knob cap by guiding the corner of the end edge in the moving block by the inclined surface of the projection and is unified to the knob cap without an axial gap.

In addition, since the knob cap and the moving block are unified by the engagement of the nail and the engagement hole, the knob can be manufactured at low costs and the manufacture man-hours can be reduced.

Since the knob cap and the moving block are separately formed, this formation method is different from a case of the unification by the double molding, wherein sufficient wall thinning can be carried out, and as a result, the weight reduction and the reduction in material costs in the knob are improved, and further, for example, since it is possible to paint the knob cap only, a clear boundary line in painting to the non-painted moving block can be obtained without masking.

A knob according to a second aspect of the present invention which is assembled in a stationary member for performing a switch operation comprises a knob cap including a bottom wall and a side wall, and a moving block including a recessed portion and fitted inside the knob cap, wherein the side wall of the knob cap is provided with nails formed at an opening end side to be oriented in a diameter inner direction, the bottom wall in the knob cap has an inner surface provided with projections formed at three locations surrounding an axis center of the knob on the circumference corresponding to a corner of an end edge of the moving block opposing the bottom wall, the projection having an inclined surface changing in height in a radial direction from the inner surface of the bottom wall, and the moving block has an outer peripheral surface along an inner surface of the side wall of the knob cap at the opening end side, the outer peripheral surface having engagement holes corresponding to the nails, wherein the nail is engaged to the engagement hole to axially unify the knob cap and the moving block, and the corner of the end edge in the moving block is in contact with the inclined surface of the projection. The knob cap is provided with a restriction rod extending axially from a position away from the axis center to protrude from the opening end, the moving block includes a swelling portion swollen in a radial direction, the swelling portion including a through passage through which the restriction rod penetrates, and the restriction rod has an end constituting a rotation side stopper in contact with a stopper at a stationary member side at the time of rotating the knob cap around the axis by a predetermined angle.

According to the second aspect of the present invention, since the restriction rod extending from the knob cap penetrates through the moving block to become the rotation side stopper, an operator can directly sense a rotation restriction position from the knob cap to obtain a highly accurate feeling without a gap.

These and other objects, features, aspects and advantages of the present invention will be become apparent to those skilled in the art from the following detailed description, which, taken in conjunction with the annexed drawings, discloses preferred embodiments of the present invention.

### BRIEF EXPLANATION OF THE DRAWINGS

Referring now to the attached drawings which form a part of this original disclosure:

FIG. 1 is a cross section showing an entire arrangement of a switch apparatus according to an embodiment of the present invention;

FIG. 2A is a front view showing an arrangement of a knob cap as viewed from the forward side;

FIG. 2B is a side view showing the arrangement of the knob cap;

FIG. 3A is a rear view showing the arrangement of the knob cap as viewed from the backward side;

FIG. 3B is a cross section taken in the direction of the arrows along line A-A in FIG. 3A;

FIG. 3C is an enlarged cross section showing a B portion in FIG. 3B;

FIG. 4A is a front view showing a moving block in the embodiment as viewed from the forward side;

FIG. 4B is a side view showing the moving block;

FIG. 5A is a back view showing the moving block as viewed from the rear side;

FIG. 5B is a cross section taken on line C-C in FIG. 5A;

FIG. 6 is a cross section showing a through passage of the moving block;

FIG. 7 is a cross section showing connecting the knob cap and the moving block;

FIG. 8 is a front view showing a case in the embodiment;

FIG. 9 is an enlarged diagram showing a stopper wall and its surroundings;

FIG. 10A is an enlarged front view showing a pulling-out prevention stopper;

FIG. 10B is an enlarged side view showing the pulling-out prevention stopper;

FIG. 10C is a cross section taken in the direction of the arrows along line E-E in FIG. 10A.

FIGS. 11A and 11B are front side perspective diagrams each showing a relation between the knob and the case;

FIG. 12 is an explanatory diagram showing a state where the knob is pressed;

FIGS. 13A, 13B and 13C are explanatory diagrams each showing an operation of a click mechanism in the embodiment;

FIGS. 14A and 14B are partial cross section development diagrams each showing an operation of the switch apparatus in a rotational direction of the knob; and

FIG. 15 is a diagram showing a conventional example.

### DETAILED DESCRIPTION OF THE PREFERRED EMBODIMENT

A selected preferred embodiment of the present invention will now be explained with reference to the drawings. It will be apparent to those skilled in the art from this disclosure that the following description of the embodiment of the present invention is provided for illustration only, and not for the purpose of limiting the invention as defined by the appended claims and their equivalents.

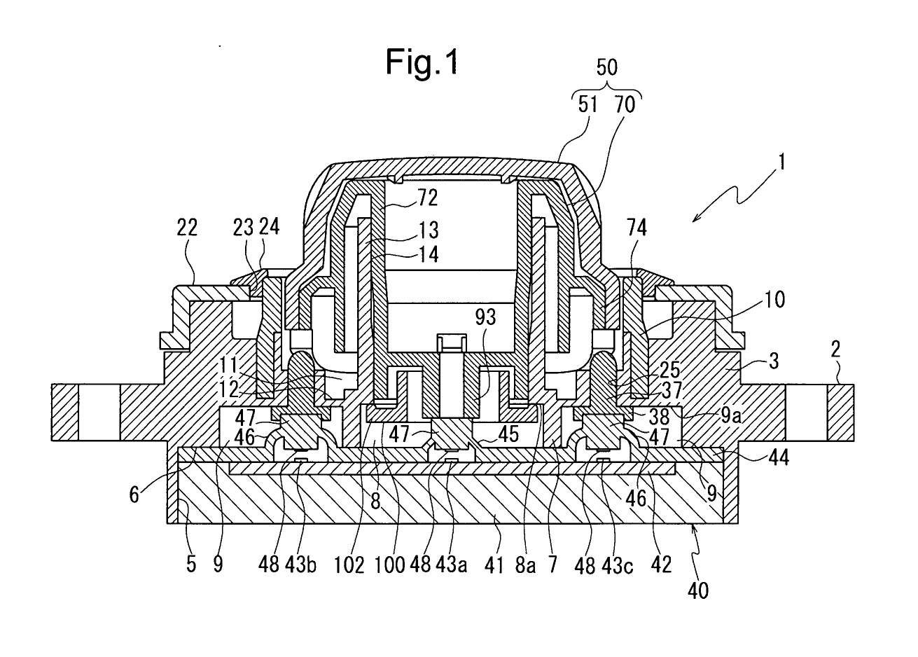

FIG. 1 is a cross section showing an entire arrangement of a switch apparatus according to an embodiment of the present invention. An outline of the switch apparatus will be first explained with reference to FIG. 1.

The switch apparatus 1 is configured by a case 2, a switch unit 40, and a knob 50 as major components. The knob 50 is supported in posture by the case 2 and protrudes to the side of an operator. The switch unit 40 is attached to the case 2 at the opposite side to the side thereof to which the knob 50 protrudes.

Hereinafter, the side to which the knob 50 protrudes, that is, the side facing the operator is called a front side or front surface and the side to which the switch unit 40 is provided is called a rear side.

The switch unit 40 includes a base 41, a substrate 42 fitted in a front surface recessed portion of the base 41 and a flexible sheet 44 overlapped on the front surface of the base 41. The substrate 42 has an outer surface flush with the front surface of the base 41 surrounding the circumference of the substrate 42. The switch unit 40 is accommodated by making a flat portion of the flexible sheet 44 be in contact with a bottom surface 6 in a unit accommodating portion 5 formed at the rear portion of the case 2.

Three sets of switch contact points 43 (43a, 43b and 43c), each of which is a pair, are arranged on the front surface of the substrate 42 on a straight line transversely intersecting a center of the case 2 as viewed from the front surface of the case 2, and the central set is positioned in the center of the case 2.

The flexible sheet 44 is provided with a cone portion 45 and arm portions 46 each protruding forwards to correspond to each set of the switch contact points 43, and the cone portion 45 corresponds to the central switch contact point 43a. The cone portion 45 and the arm portion 46 have crown portions each having a block portion 47. Each block portion 47 has an axial front end and axial rear end each having a flat surface in parallel with the flat portion of the flexible sheet 44, and the rear end is provided with a conductive contact point 48 opposing each of the switch contact points 43 as a movable contact point. In a free state of each of the cone portion 45 and the arm portion 46, each conductive contact point 48 is away from the opposing switch contact point 43.

The bottom surface 6 of the unit accommodating portion 5 is provided with a space formed thereon for receiving the cone portion 45 and the arm portion 46, which is defined as a first movable contact point accommodating space 8 receiving the cone portion 45 and a second movable contact point accommodating space 9 receiving the arm portion 46 by a ring wall 7 centered on the center of the case 2.

The case 2 has a front surface side provided with a guide ring 10 molded integrally with a body 3 a color of which is different from that of the guide ring 10. The guide ring 10 is positioned centered on the center of the body 3 and an inside of the guide ring 10 constitutes a knob-accommodating recessed portion 11. A front end of the guide ring 10 protrudes by a predetermined amount from a front surface of the body 3.

A retaining cylindrical portion 13 extends forwards by a predetermined length coaxially with the guide ring 10 from a bottom wall 12 of the knob-accommodating recessed portion 11 and a front end of the retaining cylindrical portion 13 protrudes ahead of the front end of the guide ring 10. A cylindrical hole 14 of the retaining cylindrical portion 13 penetrates through the bottom wall 12 and is opened to a first movable contact point accommodating space 8 receiving the cone portion 45. A hole diameter of this opening is smaller than an inner diameter of the ring wall 7.

In a state of inserting an inner cylinder 72 of the moving block 70 to be described later in the knob 50 into the retaining cylindrical portion 13, a rear end (pressing cylinder 93 to be described later) of the knob 50 is seated on the block portion 47 of the cone portion 45 in the flexible sheet 44.

A pulling-out prevention stopper 100 provided with a flange 102 having a larger diameter than the cylindrical hole 14 of the retaining cylindrical portion 13 is inserted into the cylindrical hole 14 from the side of the first movable contact point accommodating space 8 and is engaged to the moving block 70. Thereby the flange 102 is engaged to a bottom surface 8a of the first movable contact point accommodating space 8 to prevent the pulling-out of the knob 50.

In a free state where the knob 50 is urged forwards by a spring in a click mechanism to be described later and is not pressed backwards, the flange 102 of the pulling-out prevention stopper 100 engaged to the moving block 70 is in contact with the bottom surface 8a of the first movable contact point accommodating space 8, thereby retaining a protruding position of the knob 50 from the case 2.

A front surface of the case 2 is provided with a decorative cover 22 attached thereon and having a hole 23 surrounding the guide ring 10, and the hole 23 is provided with a decorative ring 24 attached thereto and slightly covering the front end of the guide ring 10 to expose a large part of the front end thereof.

A guide bore 25 is provided between the second movable contact point accommodating space 9 receiving the arm portion 46 of the flexible sheet 44 and the knob-accommodating recessed portion 11 to correspond to the arm portion 46. A plunger 37 provided with a flange 38 is inserted into the guide bore 25 from the side of the second movable contact point accommodating space 9 and the flange 38 of the plunger 37 is seated on the block portion 47 of the arm portion 46 and is urged forwards by the arm portion 46. In a free state, the flange 38 is in contact with a bottom surface 9a of the second movable contact point accommodating space 9 and a front end of the plunger 37 protrudes forwards ahead of the guide bore 25.

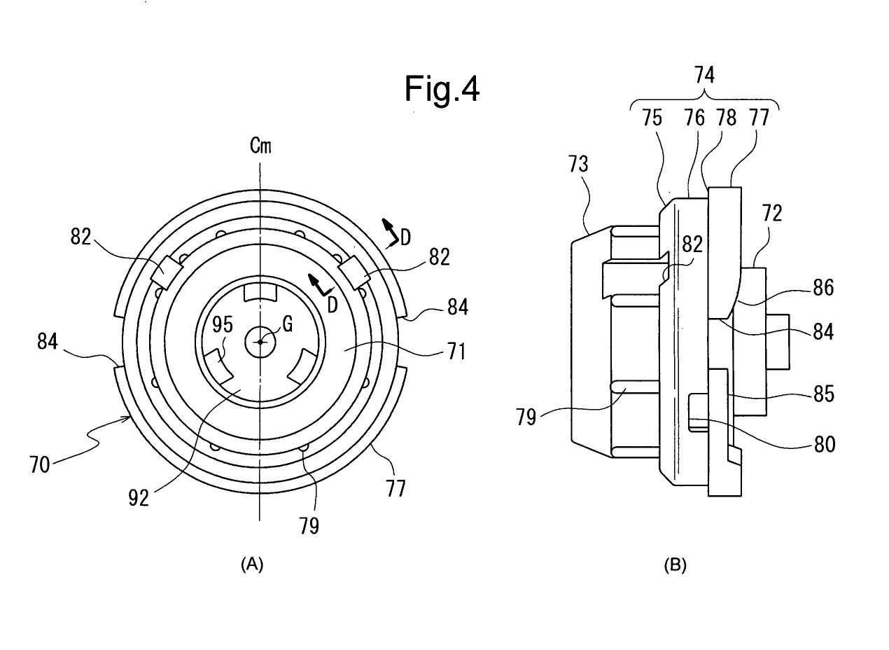

A cam surface 86 (refer to FIG. 4B) is formed in a rear end edge of a flare cylindrical portion 74 to be described later of the moving block 70 to be contactable with the front end of the plunger 37.

Based upon the above arrangement, when the knob 50 is pressed in an axial direction, that is, backwards, the rear end of the knob 50 bends the cone portion 45 to make the conductive contact point 48 in contact with the switch contact point 43a, thereby making the switch contact point 43a as the pair be in a conductive state.

Rotating the knob 50 in one direction or in the other direction causes the cam surface 86 to be in contact with the front end of the plunger 37, thereby sliding the plunger 37 backwards. In consequence, the arm portion 46 of the one or the other is bent to make the conductive contact point 48 be in contact with the switch contact point 43b or 43c, thus making the respective switch contact points of the pair be in a conductive state. Here, a rotation width of the knob 50 is defined as 30° in each direction.

Hereinafter, a detail of an arrangement of each component will be explained.

First, the knob 50 is formed of the moving block 70 bending the cone portion 45 and the arm portion 46 directly or through the plunger 37 to operate on the switch unit 40 and the knob cap 51 covering the front side of the moving block 70 and touched by fingers of an operator.

The knob cap 51 corresponds to the front outer wall portion shown in the conventional example, and the moving block 70 corresponds to the functional portion, but the knob cap 51 and the moving block 70 are not integrally molded and are respectively formed as separate components by plastic molding.

The knob cap 51 has an outer surface plated or painted for improvement on the outer appearance.

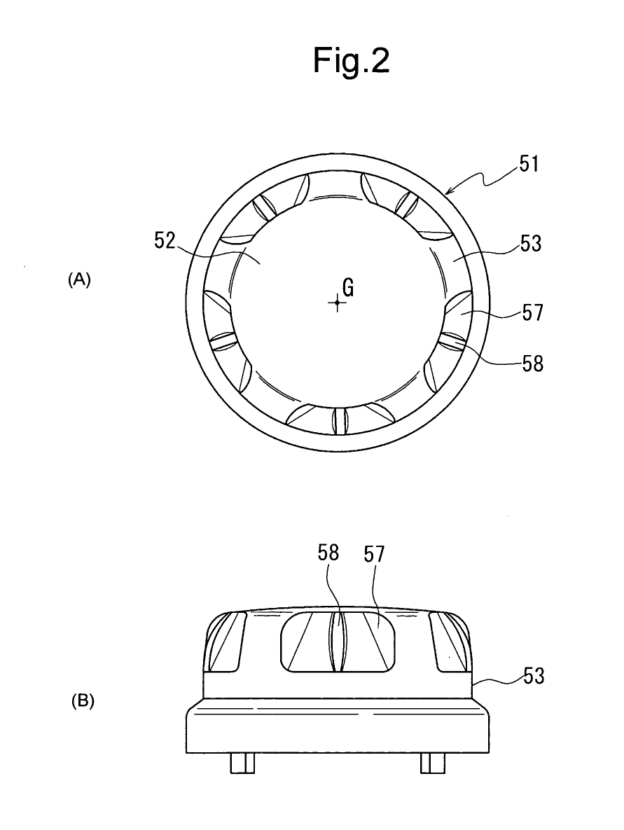

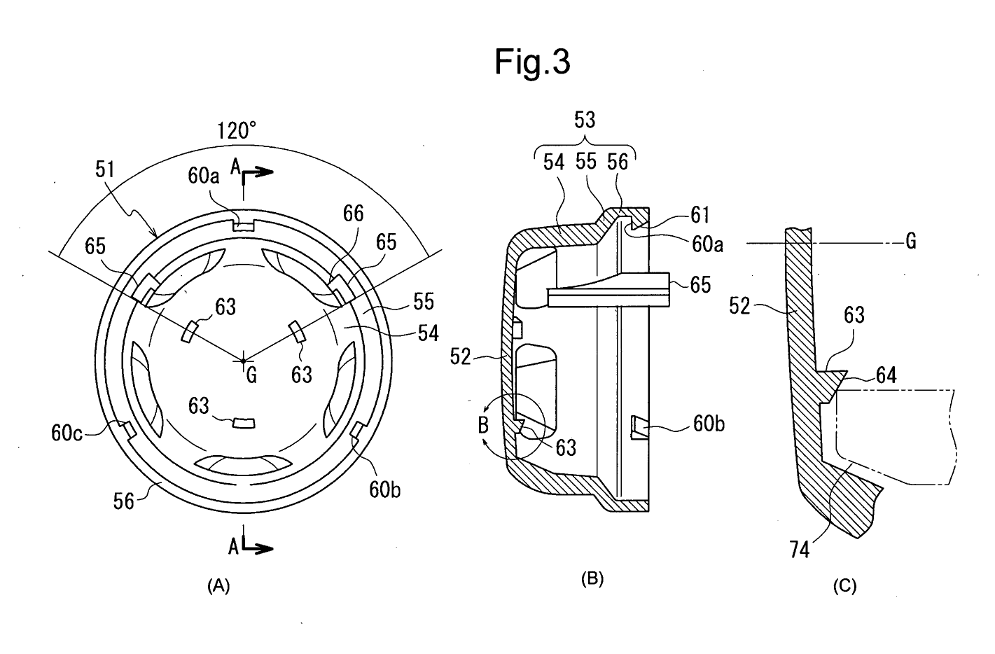

FIG. 2A is a front view showing the knob cap 51 as viewed from the forward side. FIG. 2B is a side view showing the knob cap 51. FIG. 3A is a rear view showing the knob cap 51 as viewed from the backward side. FIG. 3B is a cross section taken in the direction of the arrows along line A-A in FIG. 3A. FIG. 3C is an enlarged cross section showing a B portion in. FIG. 3B.

The knob cap 51 is basically structured of a pan configuration of a thin wall formed of a bottom wall 52 and a side wall 53. The side wall 53 is, as shown in FIG. 3B, formed in a two-step shape having a main side wall 54 connected to the bottom wall 52, an enlarged diameter portion 56 at the rear portion (opening side) and an inclined wall 55 connecting the main side wall 54 and the enlarged diameter portion 56.

As shown in FIG. 2A, on the outer appearance of the knob cap 51 as viewed from the front side, the recessed portions 57, which are formed by recessing portions in an inner direction from the side wall 53 (main side wall 54) to the bottom wall 52, are formed circumferentially equally around the axis center and a projection 58 is provided in the recessed portion 57, serving as a finger engagement at the time of rotating the knob 50.

As shown in FIG. 3A, nails 60 (60a, 60b, and 60c) are provided on the inner surface of the opening end in the enlarged diameter portion 56 of the side wall in three equally divided positions in the circumferential direction. A rear portion of the nail 60 is, as shown in FIG. 3B, formed as an inclined surface 61 which increases in height from the inner surface of the enlarged diameter portion 56 toward the forward side.

In addition, projections 63 are provided on the inner surface of the bottom surface 52 in three equally divided positions on a predetermined circumference around an axis center G. Particularly as shown in FIG. 3C, the backward front end of the projection 63 is formed as an inclined surface 64 which increases in height from the bottom wall 52 toward the axis center G.

The above predetermined circumference has a diameter which is the same as that of an inner peripheral edge of a front wall 71 to be described later of the moving block 70 and the circle is designed to pass through a center of the inclined surface 64. The nail 60 is arranged to be shifted from the projection 63 of the bottom wall 52 by angle of 60° around the axis center G.

As shown in FIG. 3A and FIG. 3B, the side wall 53 of the knob cap 51 is further provided with restriction rods 65. The restriction rods 65 are provided at both sides of one nail 63a, each extending in parallel with the axis center from a portion across the main side wall 54 and the inclined wall 55 to the backward side to protrude from the opening end of the enlarged diameter portion 56.

A horizontal section of the restriction rod 65 is formed in a block shape along a circumference around the axis center and forms a wide width surface 66 bent in an L shape at the side of the nail 60a.

Here, an intersection angle of connecting lines between each end edge of the two restriction rods 65 at the opposite side to each wide width surface 66 thereof and the axis center G is defined as 120°.

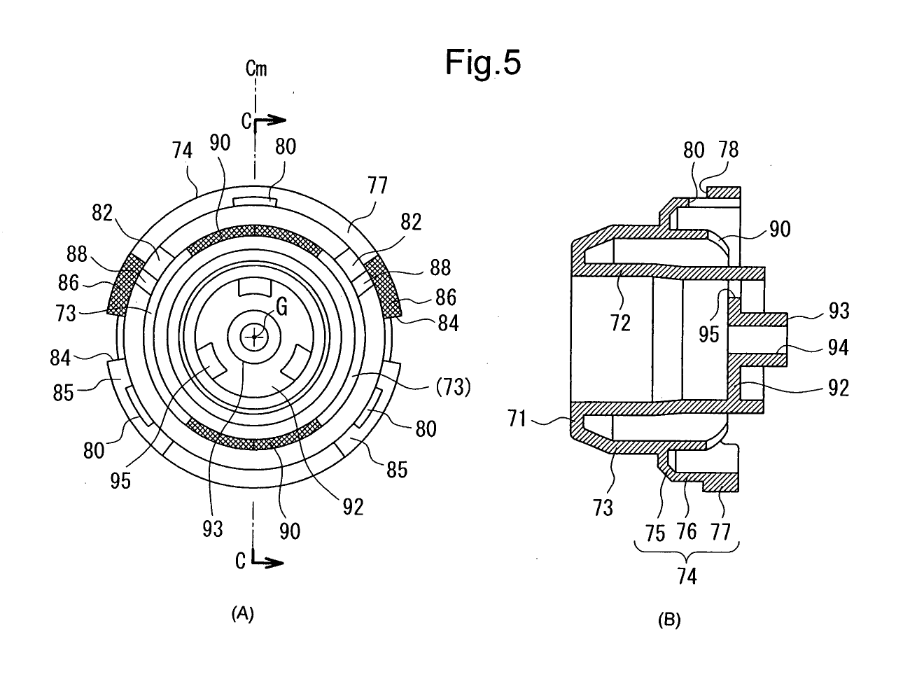

Next, FIG. 4A is a front view showing the moving block 70 as viewed from the forward side. FIG. 4B is a side view thereof. FIG. 5A is a back view showing the moving block 70 as viewed from the backward side. FIG. 5B is a cross section taken in the direction of the arrows along line C-C in FIG. 5A.

The moving block 70 includes a ring-shaped front wall 71, an inner cylinder 72 extending from an inner peripheral edge of the front wall 71 toward the backward side, and an outer cylinder 73 extending from an outer peripheral edge of the front wall 71 to the backward side, the outer cylinder 73 being shorter than the inner cylinder 72.

An axial former of an outer peripheral surface of the outer cylinder 73 is formed substantially along an inner surface of the main side wall 54 in the knob cap 51, provided with axial beads 79 formed therein, and has an inclined surface at the side of the front wall 71 for avoiding interference with the recessed portion 57 in the knob cap 51.

The axial latter of the outer cylinder 73 is surrounded by the flare cylindrical portion 74 extending from an axial intermediate position to the backward side.

The flare cylindrical portion 74 comprises an inclined portion 75 an outer peripheral surface of which is formed substantially along an inner surface of the inclined wall 55 in the knob cap 51, a fitting portion 76 having an outer diameter aligned with the inner surface of the enlarged diameter portion 56 in the knob cap 51, and a shoulder portion 77 provided with a stepped surface 78 having an outer diameter extending further from the enlarged diameter portion 56, in which an outer peripheral surface is flush with the outer peripheral surface of the enlarged diameter portion 56, and opposing an opening end surface of the enlarged diameter portion 56.

As described above, the moving block 70 comprises the front wall 71, the inner cylinder 72, the outer cylinder 73, and the flare cylindrical portion 74, any of which is formed in a thin wall shape, and is formed by producing particularly a large-capacity space inside the inner cylinder 72 by wall thinning, and further, each portion of a space between the inner cylinder 72 and the outer cylinder 73 and a space between the outer cylinder 73 and the flare cylindrical portion 74.

The fitting portion 76 is provided with engagement holes 80 formed in three equally divided positions in the circumferential direction around the axis center to correspond to the nails 60 of the knob cap 51. A circumferential width of the engagement hole 80 is set larger than a circumferential width of the nail 60.

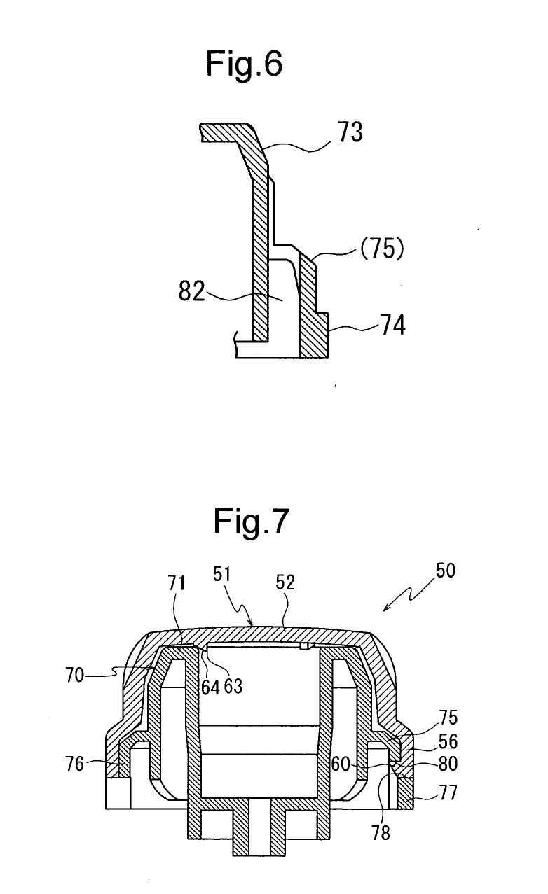

The moving block 70 is, as shown in FIG. 6 which is a cross section taken on line D-D in FIG. 4A, provided with through passages 82 each formed by notching an outer peripheral surface of the outer cylinder 73 and penetrating the inclined portion 75 of the flare cylindrical portion 74 and a connecting portion with the outer cylinder 73 to extend in parallel with the axis center and correspond to the restriction rod 65 of the knob cap 51. A circumferential width of the through passage 82 is aligned with that of the restriction rod 65.

In the following explanation, in FIG. 4A and FIG. 5A, a straight line passing an intermediate point between the two through passages 82 in the circumferential direction and an axis center is explained as a reference line Cm.

On a diameter line vertical to the reference line Cm in a back view of FIG. 5A, first notches 84 (refer to FIG. 4B) each having a predetermined width in a circumferential direction are formed in the shoulder portion 77 in the flare cylindrical portion 74. The first notch 84 opposes the plunger 37 in a neutral position in a rotation direction of the knob 50 incorporated in the case 2. When the knob 50 is pressed down, the shoulder portion 77 interferes with the first notch 84 to prevent the plunger 37 from being pressed.

As shown in FIG. 4B, a cam surface 86 in contact with a front end of the plunger 37 is formed in a front end (rear end edge) of the shoulder portion 77 in the side of the through passage 82 in the circumferential direction to be adjacent to the first notch 84.

Second notches 85 are formed in the shoulder portion 77, each having a predetermined range at the opposite side to the cam surface 86 to be connected to the first notch 84. This arrangement causes one plunger 37 not to be pressed in while one cam surface 86 presses the other plunger 37.

As shown in FIG. 5A, the through passage 82 is viewed as a rectangular hole formed between the outer cylinder 73 and the flare cylindrical portion 74 from the back surface.

A support wall 88 is disposed over between the outer cylinder 73 and the flare cylindrical portion 74 along a section of the through passage 82 as the rectangular hole closer to the adjacent first notch 84 and is in contact with the restriction rod 65 inserted into the through passage 82 at the opposite end to the wide width surface 66.

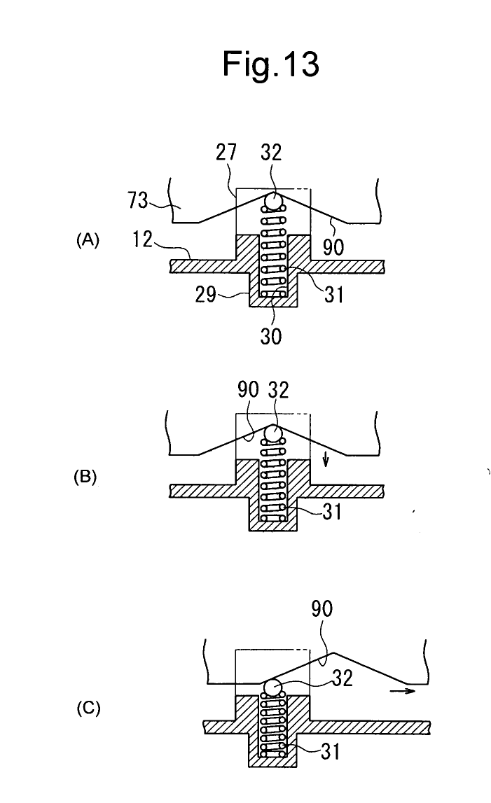

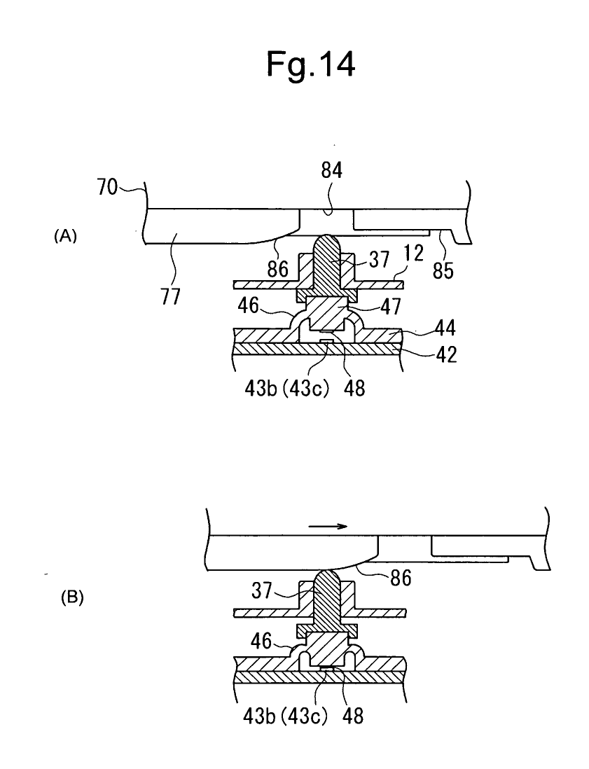

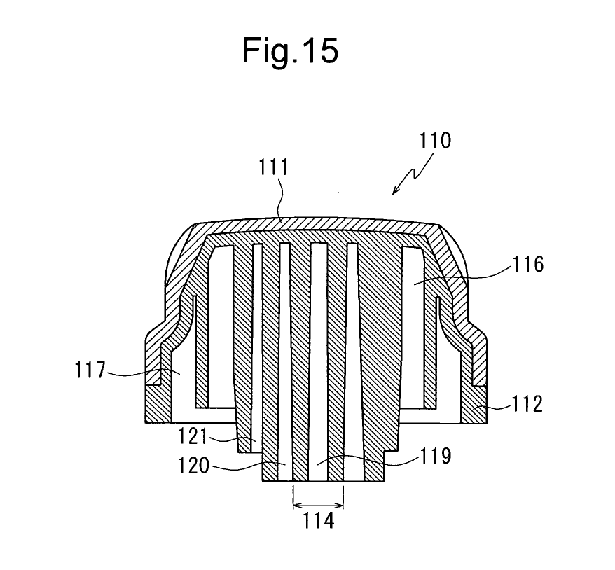

In the rear end edge of the outer cylinder 73, a click cam surface 90 notched in a V shape (refer to FIGS. 13A, 13B and 13C) is formed symmetrically around the axis center and the root is positioned on the reference line Cm. Each half in the circumferential width of the click cam surface 90 around the root center is set larger than 30°.

As shown in FIG. 5B, the inner cylinder 72 has a front portion (side of the front wall 71) having a large diameter, a rear portion having a diameter slightly smaller than that of the front portion, and an intermediate portion as an inclined portion for facilitating cutting at molding.

A partition wall 92 is disposed near the rear end of the inner cylinder 72 and a pressing cylinder 93 extends backwards on the axis center from the partition wall 92 to protrude over the rear end of the inner cylinder 72. A through bore 94 is formed in the pressing cylinder 93 to establish communication between the forward side and the backward side of the partition wall 92.

In FIG. 4A and also in FIG. 5A, the engagement holes 95 are formed to abut to the inner surface of the inner cylinder 72 in the three equal divided positions in the circumferential direction, so that the pulling-out prevention stopper 100 is engaged thereto.

The knob cap 51 and the moving block 70 as constructed above are connected in such a manner that the knob cap 51 covers the moving block 70 from the forward side while sliding the two restriction rods 65 along the through passages 82 of the moving block 70.

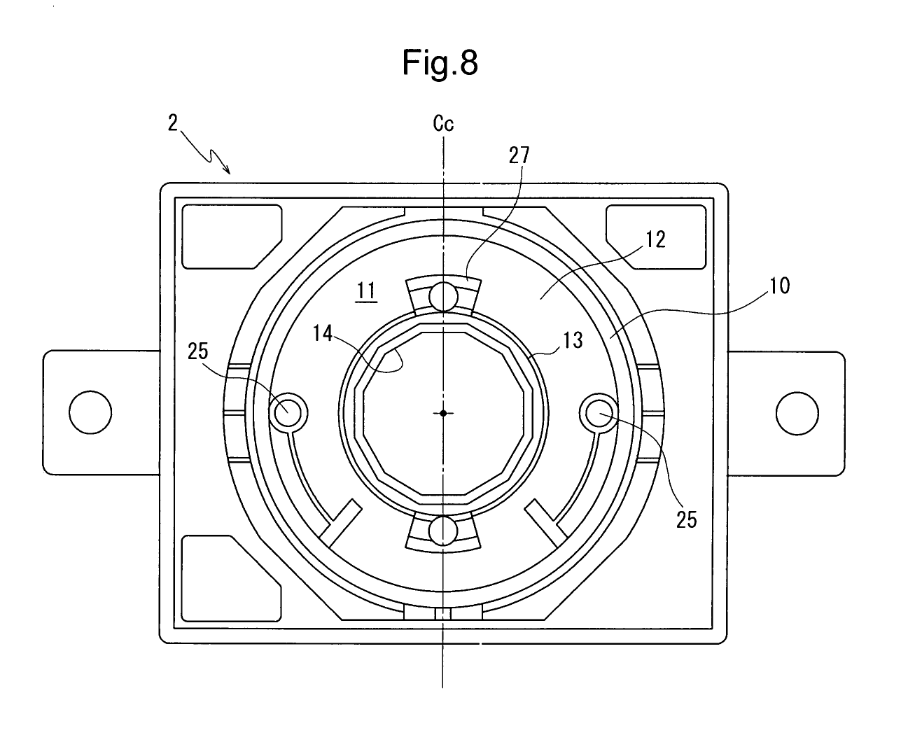

FIG. 7 is a cross section showing the knob 50 integrated by uniting the knob cap 51 and the moving block 70.

At the time of sliding the knob cap 51 to the moving block 70, the front wall 71 of the moving block 70 is closer relative to the bottom wall 52 of the knob cap 51. since the projections 63 are disposed on the bottom wall 52 in the three equally divided positions on the circumference corresponding to the inner peripheral edge of the front wall 71 in the moving block 70, when the knob cap 51 is further slid, the corner of the inner peripheral edge in the front wall 71 is in contact with the inclined surface 64 in the front end of the projection 63 to automatically align the front end of moving block 70 on the axis center of the knob cap 51.

Simultaneously with it, the nail 60 disposed in the enlarged diameter portion 56 in the rear end of the knob cap 51 rides over the inclined portion 75 in the flare cylindrical portion 74 of the moving block 70, and thereafter, is fitted into the engagement hole 80 of the fitting portion 76 to be engaged.

Therefore, the knob cap 51 and the moving block 70 are aligned in the axis center and are also integral with each other without an axial gap.

In addition, the opening end edge (end surface of the enlarged diameter portion 56) of the knob cap 51 is in contact with the stepped surface 78 of the shoulder portion 77 in the moving block 70.

At this moment, as shown in. FIG. 3A, since the two restriction rods 65 are not positioned in the symmetrical positions around the axis center, the positioning of the knob cap 51 and the moving block 70 in the rotational direction is not in error made by inserting and sliding the restriction rod 65 into the through passage 82 of the moving block 70.

Since the engagement hole 80 of the moving block 70 is wider that the circumferential width of the nail 60 in the knob cap 51, when the restriction rod 65 of the knob cap 51 is slid along the through passage 82, the nail 60 is securely engaged without pulling out of the engagement hole 80.

In addition, since the circumferential width of the through passage 82 is aligned with that of the restriction rod 65, the knob cap 51 and the moving block 70 are integral also in the rotation direction.

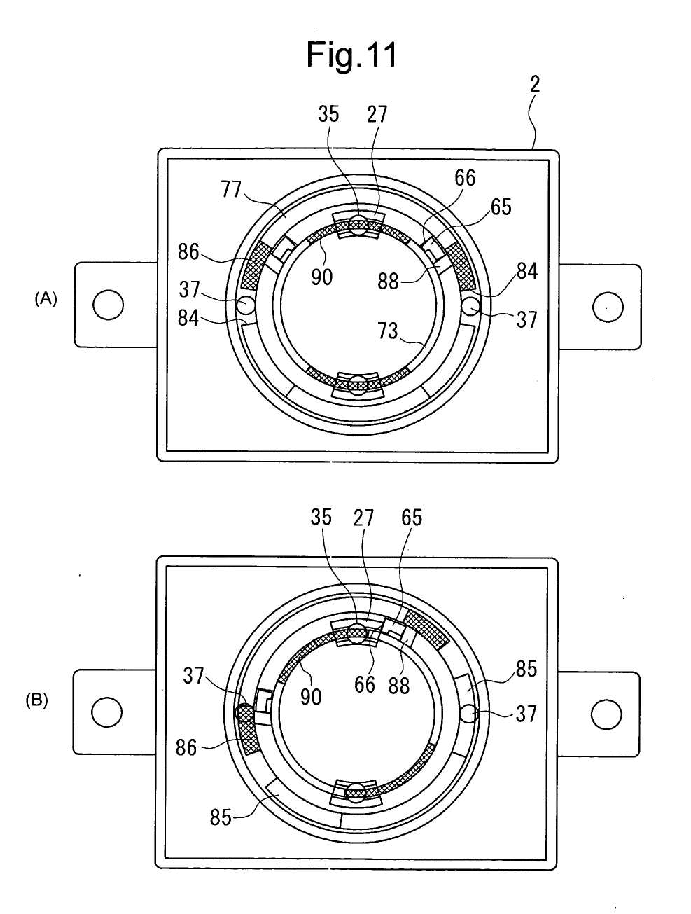

As shown in FIG. 11 to be illustrated later, the end of the restriction rod 65 at the opposite side to the wide width surface 66 is in contact with the support wall 88 formed between the outer cylinder 73 and the flare cylindrical portion 74.

Next, FIG. 8 is a front view showing the case 2 as viewed from the forward side.

Hereinafter, the case 2 will be explained by defining a vertical line passing a center (axis line) of the retaining cylindrical portion 13 in the figure as a reference line Cc.

The knob-accommodating recessed portion 11 is defined by surrounding the retaining cylindrical portion 13 by the guide ring 10 coaxial therewith.

It should be noted that the cylindrical hole 14 of the retaining cylindrical portion 13 is formed of polygon having 12 corners to reduce a contact area with the inner cylinder 72 of the moving block 70, thus reducing a resistance at the time of rotating the knob 50.

The bottom wall 12 of the knob-accommodating recessed portion 11 is provided with guide bores 25 in close proximity to the inner surface of the guide ring 10 on a diameter line vertical to the reference line Cc for inserting the plunger 37 therein.

Stopper walls 27 in parallel with the retaining cylindrical portion 13 in the circumferential direction rise forwards on the reference line Cc from the bottom wall 12 of the knob-accommodating recessed portion 11. It should be noted that in the front view in FIG. 8, the near side is the forward side.

A position of the stopper wall 27 from the axis center corresponds to the space between the outer cylinder 73 and the flare cylindrical portion 74 in the moving block 70.

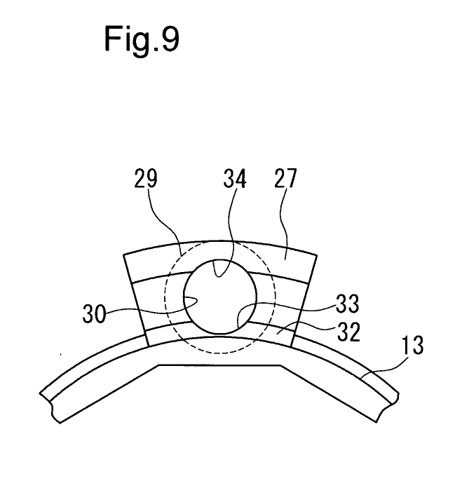

As shown in FIG. 9, a spring holder 29 is formed from the bottom wall 12 to the backward side to be positioned between the stopper wall 27 and the retaining cylindrical portion 13 and a spring bore 30 accommodating a spring 31 (refer to FIG. 13) for a click mechanism is opened forwards.

As shown in FIG. 8 and FIG. 9, the outer periphery of the retaining cylindrical portion 13 is provided with a ball guide 32 opposing the stopper wall 27, wherein the ball guide 32 is equipped with a groove 33 for axially guiding a click ball 35 (refer to FIG. 13). The groove 33 is formed of a partial cylindrical surface.

The stopper wall 27 also is provided with a partial cylindrical surface 34 on a surface opposing the retaining cylindrical portion 13 to form a ball retaining portion for retaining the click ball 35 to be axially movable in cooperation with a ball guide 32.

The spring 31 and the click ball 35 constitute the click mechanism in cooperation with a click cam surface 90 of the outer cylinder 73.

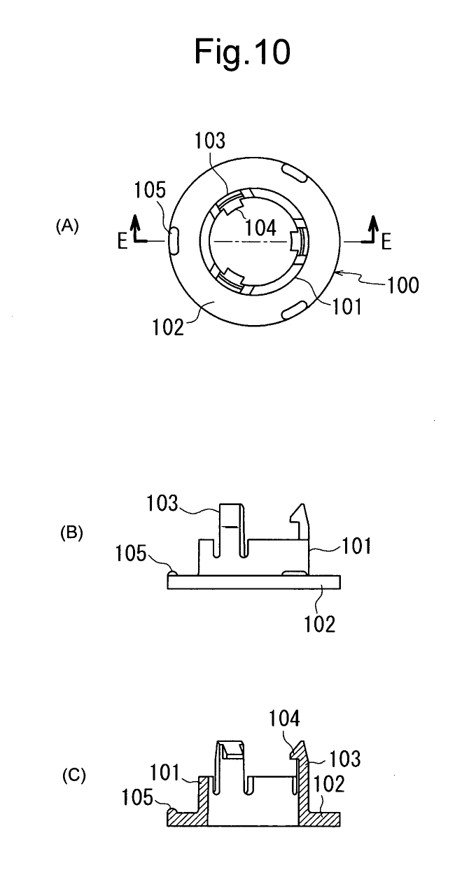

FIG. 10A is an enlarged front view showing the pulling-out prevention stopper 100. FIG. 10B is an enlarged side view showing the pulling-out prevention stopper 100. FIG. 10C is a cross section taken in the direction of the arrows along line E-E in FIG. 10A.

The pulling-out prevention stopper 100 is provided with a flange 102 extending outwardly from one end of a cylindrical portion 101 and has nails 104, each positioned at a front end of a leg piece 103 extending from a position offset to the side of the flange 102 from an edge of the cylindrical portion 101 to the other side. Here, the three leg pieces 103 are provided corresponding to the engagement holes 95 of the partition wall 92.

In addition, projections 105 are disposed in three equally divided locations in a circumferential direction on a surface of the flange 102 at the side of the cylindrical portion 101.

The cylindrical portion 101 is inserted into the cylindrical hole 14 from the side of the first movable contact point accommodating space 8 and the leg piece 103 is inserted into the engagement hole 95 of the partition wall 92 to engage the nail 104 to the front surface of the partition wall 92. Therefore, the pulling-out prevention stopper 100 is connected to the moving block 70 and the flange 102 is in contact with the bottom surface 8a of the first movable contact point accommodating space 8 at the projection 105 to prevent the pulling-out of the knob 50.

The knob 50 is incorporated in the case 2 by aligning the reference line Cc of the case 2 with the reference line Cm of the moving block 70 and is in a state shown in FIG. 1 in an axial direction in a free state. A gap between the end of the retaining cylindrical portion 13 and the front wall 71 of the moving block 70 is set larger than a stroke length at the time of pressing the knob 50, so that the retaining cylindrical portion 13 is not in contact with the, front wall 71 before the conductive contact point 48 is in contact with the switch contact point 43.

FIG. 11A and FIG. 11B are front perspective views each showing a relation between the knob 50 and the case 2.

As shown in FIG. 11A, in a free state, the restriction rod 65 extending from the knob 50 is away from the stopper wall 27 of the vase 2 in a rotation direction.

In addition, as shown in FIG. 14A, the cam surface 86 of the shoulder portion 77 in the knob 50 (moving block 70) is out of the plunger 37 and the plunger 37 opposes the first notch 84 adjacent to the cam surface 86. It should be noted that FIGS. 14A and 14B are viewed along the outer periphery of the shoulder portion 77 from the outside.

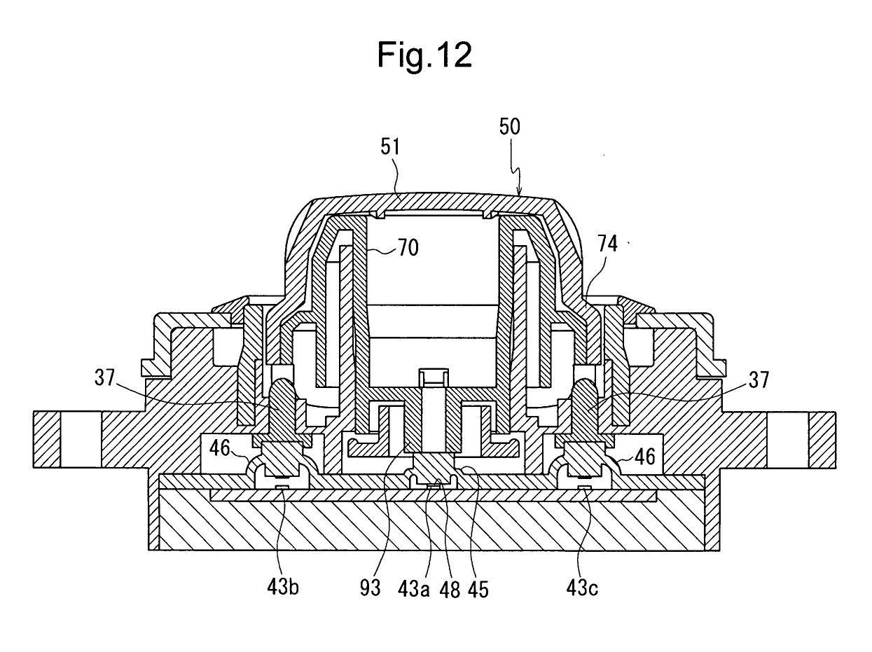

FIG. 12 shows a state where the knob 50 is being pressed.

The rear end of the pressing cylinder 93 in the moving block 70 bends the cone portion 45 to make the conductive contact point 48 be in contact with the switch contact point 43a, making the switch contact point 43a be in a conductive state.

At this time, since the plunger 37 opposes the first notch 84 of the flare cylindrical portion 74, even if the moving block 70 moves backwards (downwards in the figure), the plunger 37 is not pressed in, and the arm portion 46 is not bent to make the switch contact point 43b or 43c be in a conductive state.

FIGS. 13A, 13B and 13C each show an operation of the click mechanism, where the outer cylinder 73 of the moving block 70 is viewed along the outer periphery from the outside.

FIG. 13A shows a free state of the click mechanism where the click ball 32 forwards urged by the spring 31 is positioned in the root of the click cam surface 90 formed in the outer cylinder 73, thereby retaining the knob 50 to be in a protruding position from the case 2.

When the knob 50 is pressed in by a finger, as shown in FIG. 13B, in a state where the click ball 32 is being positioned in the root of the click cam surface 90, the outer cylinder 73 compresses the spring 31. An arrow mark shows a moving direction of the outer cylinder 73.

When the finger is released, the knob 50 is returned to a free state by the urging force of the spring 31 and the switch contact point 43a is in a non-conductive state.

When the knob 50 is rotated in one direction (counterclockwise direction in FIGS. 11A and 11B) next, the left cam surface 86 (in FIG. 11A) of the shoulder portion 77 in the moving block 70 moves on the plunger 37, which presses down the plunger 37 as shown in FIG. 14B. The arm portion 46 is bent to make the conductive contact point 48 be in contact with the switch contact point 43b, so that the switch contact point 43b is in a conductive state.

The other plunger 37 at the opposite side to the pressed side is not pressed since it enters into a region of the second notch 85.

Since the restriction rod 65 is, as shown in FIG. 11 B, in contact with the stopper wall 27 in a position where the knob 50 is rotated by 30° from a free state, the knob 50 can not be rotated more than that. At this time, the restriction rod 65 is securely in contact with the stopper wall 27 since the restriction rod 65 is provided with the wide width surface 66.

In addition, since the restriction rod 65 extends from the knob cap 51 which an operator touches, the operator can directly sense that the restriction rod 65 is in contact with the stopper wall 27 at a rotation restriction position to obtain a high accuracy feeling, which is different from a case where there is produced a gap due to existence of the other member therebetween.

It should be noted that since the moving block 70 is provide with the support wall 88 backing and supporting the restriction rod 65, even when a further rotational force is applied to the knob 50 in error, there is no possibility that the restriction rod 65 is damaged.

While rotating the knob 50, the click cam surface 90 compresses the spring 31 through the click ball 32 in the click mechanism, but even in a position where the restriction rod 65 is in contact with the stopper wall 27, since the click ball 32 is set to be positioned on the inclined surface of the click cam surface 90 as shown in FIG. 13C, if the rotational force is loosened after making the switch contact point 43b be in a conductive state, the knob 50 is automatically returned to a free state.

Similarly to a case of rotating the knob 50 in the other direction, the switch contact point 43c becomes conductive.

In the present embodiment, the corner of the inner peripheral edge of the front wall 71 corresponds to the corner of the end edge of the moving block in the present invention and the flare cylindrical portion 74 corresponds to the swelling portion. The cylindrical hole of the inner cylinder 72 corresponds to the recessed portion. The through passage 82 corresponds to the engagement portion.

In addition, the case 2 corresponds to the stationary member and the stopper wall 27 corresponds to the stopper.

The embodiment is configured as described above, wherein the knob 50 comprises the knob cap 51 having the bottom wall 52 and the side wall 53, and the moving block 70 formed in a wall thinning shape and engaged inside the knob cap 51, wherein the side wall 53 of the knob cap 51 is provided with nails 60 formed at an opening end side to be oriented in a diameter inner direction, the bottom wall 52 in the knob cap 51 has an inner surface provided with projections 63 formed at three locations surrounding an axis center of the knob 50 on the circumference corresponding to the corner of the inner peripheral edge of the front wall 71 in the moving block 70 opposing the bottom wall 52, the projection 63 having an inclined surface 64 changing in height in a radial direction from the inner surface of the bottom wall 52, and the moving block 70 has the outer peripheral surface along the inner surface of the side wall 53 of the knob cap 51 at the opening end side, the outer peripheral surface having an engagement hole 80 corresponding to the nail 60, wherein the nail 60 is engaged to the engagement hole 80 to axially unify the knob cap 51 and the moving block 70 and make the corner of the inner peripheral edge of the front wall 71 in the moving block 70 be in contact with the inclined surface 64 of the projection. Therefore, the moving block 70 is automatically aligned on the axis of the knob cap 51 by guiding the corner of the inner peripheral edge in the front wall 71 with the inclined surface 64 and is unified to the knob cap 51 without a gap in an axial direction.

In addition, since the knob cap 51 and the moving block 70 is unified only by the engagement of the nail 60 and the engagement hole 80, the knob 50 can be manufactured at low costs with no necessity of use of an adhesive agent, and the operation hours can be reduced.

Since the knob cap 51 and the moving block 70 are separately molded and it is possible to paint the knob cap 51 only, a clear boundary line in painting to the non-painted moving block 70 can be obtained without masking.

In addition, since the front wall 71 in the moving block 70 is a ring-shaped portion left by the wall thinning inside the moving block 70 and the corner of the inner peripheral edge in the inner wall 71 is made in contact with the inclined surface 64, it is not required to provide a separate hole for the center alignment.

Since the knob cap 51 is further provided with the restriction rod 65 extending axially from a position away from the axis center and the moving block 70 includes the through passage 82 engaging to the restriction rod 65 in a circumferential direction, the knob cap 51 and the moving block 70 is securely integral also in a rotation direction. Therefore, even if a large rotation operation force is applied to the knob cap 51, the knob cap 51 can not idle to the moving block 70.

Particularly the through passage 82 is provided in the flare cylindrical portion 74 swollen radially, the restriction rod 65 protrudes from the opening end of the knob cap 51 to penetrate through the through passage 82, and the end of the restriction rod 65 serves as the rotation side stopper in contact with the stopper wall 27 in the side of the case 2 at the time of rotating the knob cap 51 around the axis by a predetermined angle. Therefore, an operator can directly sense the rotation restriction position from the knob cap 51 to obtain the high accuracy feeling without a gap.

In addition, since in the restriction rod 65, the side in contact with the stopper wall 27 constitutes the wide width surface 66, even if the stopper wall 27 is formed in a thin wall shape, the restriction rod 65 is securely in contact with the stopper wall 27 at the rotation restriction position.

Further, since the moving block 70 is provided with the support wall 88 in contact with the end of the restriction rod 65 at the opposite side to the end in contact with the stopper wall 27 of the restriction rod 65, even in a case where the an excessive rotation force is applied to the knob 50, there is no possibility that the restriction rod 65 is damaged.

In addition, since the two restriction rods 65 are provided at positions out of the symmetrical positions around the axis center of the knob cap 51, the rotation force applied to the knob cap 51 can be securely transmitted to the moving block 70. Further, since the restriction rod 65 can be inserted into the moving block 70 at the set angle position only, it is easy to position the knob cap 51 to the moving block 70.

It should be noted that the embodiment is simply taken as an example of the present invention and the specific configuration of the knob cap 51, the moving block 70 or the like is not limited to the illustrated one. The number of the nails 60 or the projections 63 in the knob cap 51 may be four or more, and the number of the restriction rods 65 may be one depending on the rotation direction of the knob or three or more depending on the rotation load.

The switch apparatus 1 is of a three-circuit switching type having the switch contact point 43a which becomes in a conductive state by the pressing-in of the knob 50, and the switch contact points 43b and 43c which become in a conductive state by the rotation of the knob 50 but the present invention is not limited thereto. The knob of the present invention may be applied to various types of switch apparatuses and in addition to the switch apparatus, the present invention may be applied to various types of knobs which have needs of weight lightening and cost reduction by the thickness cutting inside the knob

While only selected preferred embodiments have been chosen to illustrate the present invention, it will be apparent to those skilled in the art from this disclosure that various changes and modifications can be made herein without departing from the scope of the invention as defined in the appended claims. Furthermore, the foregoing description of the preferred embodiments according to the present invention is provided for illustration only, and not for the purpose of limiting the invention as defined by the appended claims and their equivalents.

1. A knob comprising:
a knob cap including a bottom wall and a side wall; and
a moving block including a recessed portion and fitted inside the knob cap, wherein
the side wall of the knob cap is provided with nails formed at an opening end side to be oriented in a diameter inner direction,
the bottom wall in the knob cap has an inner surface provided with projections formed at at least three locations surrounding an axis center of the knob on the circumference corresponding to a corner of an end edge of the moving block opposing the bottom wall, the projection having an inclined surface changing in height in a radial direction from the inner surface of the bottom wall, and
the moving block has an outer peripheral surface along an inner surface of the side wall of the knob cap at the opening end side, the outer peripheral surface having engagement holes corresponding to the nails, wherein
the nail is engaged to the engagement hole to axially unify the knob cap and the moving block, and the corner of the end edge in the moving block is in contact with the inclined surface of the projection.

2. A knob according to claim 1, wherein
the knob cap is further provided with a restriction rod extending axially from a position away from the axis center, and
the moving block is provided with an engagement portion engaging to the restriction rod in a circumferential direction.

3. A knob assembled in a stationary member for performing a switch operation comprising:
a knob cap including a bottom wall and a side wall; and
a moving block including a recessed portion and fitted inside the knob cap, wherein
the side wall of the knob cap is provided with nails formed at an opening end side to be oriented in a diameter inner direction,
the bottom wall in the knob cap has an inner surface provided with projections formed at three locations surrounding an axis center of the knob on the circumference corresponding to a corner of an end edge of the moving block opposing the bottom wall, the projection having an inclined surface changing in height in a radial direction from the inner surface of the bottom wall, and
the moving block has an outer peripheral surface along an inner surface of the side wall of the knob cap at the opening end side, the outer peripheral surface having engagement holes corresponding to the nails, wherein
the nail is engaged to the engagement hole to axially unify the knob cap and the moving block, and the corner of the end edge in the moving block is in contact with the inclined surface of the projection,
the knob cap is provided with a restriction rod extending axially from a position away from the axis center to protrude from the opening end,
the moving block includes a swelling portion swollen in a radial direction, the swelling portion including a through passage through which the restriction rod penetrates, and
the restriction rod has an end constituting a rotation side stopper in contact with a stopper at a stationary member side at the time of rotating the knob cap around the axis by a predetermined angle.

4. A knob according to claim 3, wherein
the moving block is provided with a support wall in contact with the end of the restriction rod at the opposite side to the end in contact with the stopper at the stationary member side.

5. A knob according to claim 3, wherein
the two restriction rods are provided at positions out of the symmetrical positions around the axis center of the knob cap.

6. A knob according to claim 1, wherein
the moving block has an end opposing the bottom wall of the knob cap, the end being formed in a ring shape by a recessed portion,
the corner of the end edge is a corner of an inner peripheral edge of the ring-shaped end, and
the inclined surface of the projection increases in height closer to the axis center from the bottom wall.

7. A knob according to claim 4, wherein
the two restriction rods are provided at positions out of the symmetrical positions around the axis center of the knob cap.

8. A knob according to claim 2, wherein
the moving block has an end opposing the bottom wall of the knob cap, the end being formed in a ring shape by a recessed portion,
the corner of the end edge is a corner of an inner peripheral edge of the ring-shaped end, and
the inclined surface of the projection increases in height closer to the axis center from the bottom wall.

9. A knob according to claim 3, wherein
the moving block has an end opposing the bottom wall of the knob cap, the end being formed in a ring shape by a recessed portion,
the corner of the end edge is a corner of an inner peripheral edge of the ring-shaped end, and
the inclined surface of the projection increases in height closer to the axis center from the bottom wall.

10. A knob according to claim 4, wherein
the moving block has an end opposing the bottom wall of the knob cap, the end being formed in a ring shape by a recessed portion,
the corner of the end edge is a corner of an inner peripheral edge of the ring-shaped end, and
the inclined surface of the projection increases in height closer to the axis center from the bottom wall.

11. A knob according to claim 5, wherein
the moving block has an end opposing the bottom wall of the knob cap, the end being formed in a ring shape by a recessed portion,
the corner of the end edge is a corner of an inner peripheral edge of the ring-shaped end, and
the inclined surface of the projection increases in height closer to the axis center from the bottom wall.
